(19) United States
(12) Patent Application Publication
(10) Pub. No.: US 2009/0221736 A1
(43) Pub. Date: Sep. 3, 2009

(54) Water-based ink composition for improved crockfastness

(76) Inventor: Charles Douglas McCurry, Morganton, NC (US)

Correspondence Address: MACCORD MASON PLLC, 300 N. GREENE STREET, SUITE 1600, P. O. BOX 2974, GREENSBORO, NC, 27402, US

(21) Appl. No.: 12/074,253

(22) Filed: Feb. 29, 2008

(51) Int. Cl. C08K 3/34

(52) U.S. Cl. 524/451

(57) ABSTRACT

A the water-based ink composition. The ink composition preferably includes a very low Tg° C. polymer component for providing adhesion to the substrate and wet rub resistance; a polyurethane dispersion for providing dry rub resistance; and a de-tackifier component for providing dry rub resistance.

### BACKGROUND OF THE INVENTION

(1) Field of the Invention

The present invention relates generally to ink compositions for printing on a substrate and, more particularly to a water-based ink composition having improved adhesion and wet and dry rub resistance.

(2) Description of the Prior Art

Early inks were made from combinations of materials such as soot, berries, oils, water, minerals, metals, plants and animals. Modern inks are complex formulations made of solvents, pigments, dyes, resins, lubricants, solubilizers, particulate matter, fluorescers and other materials. The various components provide the desired properties such as color, thickness and adhesion, for a given purpose.

Inks often include a colorant such as dye or pigments but may also be clear or semi-transparent. Dyes are desirable because they are generally much stronger than pigment-based inks and can produce more color of a given density per unit of mass. However, because dyes are dissolved in the liquid phase, they have a tendency to soak into substrates, thus making the ink less efficient and also potentially allowing the ink to bleed at the edges of an image, producing poor quality printing. Pigmented inks, on the other hand, tend to stay on the surface of substrates, meaning that less ink is required to create the same intensity of color, but entail adhesive components to prevent removal of the pigment from the surface by mechanical abrasion.

The industrial importance of pigment-based inks has increased in recent times. This is driven, in part, by the development of many new synthetic substrates that are incapable of being printed with conventional inks, and consumers' preferences that their goods be printed with brand identifiers, aesthetically pleasing designs or functional markings. In order to adapt pigment-based inks for use in a variety of applications, namely low surface tension substrates, others have employed high loads of volatile organic compounds (“VOC's”), thereby reducing the dynamic surface tension of the ink's binder polymer. However, volatile organic compounds such as alcohols, esters, ketones, aromatics and aliphatics create environmental hazards in their production, disposal and use. They are also expensive. One example of an ink used on an a low surface tension substrate is set forth in U.S. Pat. No. 5,458,590 to Schleinz et al., which employs a solvent blend to impart the desired surface tension to the ink. In addition to the environmental problems associated with high VOC's, these inks provide less than ideal wet rub resistance, on the order of a crockfastness rating of 4.0 or slightly higher.

It has also been recognized that adding small amounts of wax to a polymer adhesive improves the dry rub properties. This is set forth in U.S. Pat. No. 5,458,590 to Schleinz et al., which shows using 0.5-5.0% wax, and in US patent application US 2007/0100025 A1 to Steiner et al., which shows using 0.1 to 2.0% waxes.

Still others have devised methods to adhere ink to low surface tension substrates, such as surface pre-treatment via corona discharge or use of a primer, as set forth in US Patent Application 2006/0246263 to Yahiaoui et al. Both these methods require an additional step in the printing process, thereby creating more expense and opportunity for inadvertently damaging the substrate.

For an ink to be useful, it needs to be in a medium capable of binding with a substrate, either chemically or physically. Where physical binding is desirable, the ink's medium must have adhesive characteristics, and preferably be somewhat flexible to withstand distortions of the substrate. The flexibility of an aqueous polymer is typically expressed as its glass transition temperature, or Tg° C. Lower Tg° C.'s generally correlate to greater elongation without fracturing. The elongation property is significant in polymer chemistry in general, but particularly important in adhesive and coloring, because the flexibility/elongation of a formula's polymer also affects rub resistance. Specifically, flexibility and softness associated with lower Tg° C. polymers provide a high degree of grab and tack, which is expressed as a high coefficient of friction (CoF). The higher the CoF, the more likely the polymer is to “grab onto” and be “carried off by” some other substrate, thereby lowering the composition's dry rub resistance. Thus, in conventional inks, the desirable properties of adhesion and flexibility are at the expense of rub resistance. Alternatively, improving rub resistance conventionally creates adhesion and flexibility problems.

Thus, there remains a need for an ink composition that is environmentally friendly, useful on a variety of substrates including those with low surface tensions, which has desirable wet and dry rub properties, and which can be incorporated into conventional printing systems without requiring additional steps or equipment.

### SUMMARY OF THE INVENTION

The present invention is directed to an environmentally friendly ink composition that exhibits improved wet rub and dry rub resistance, and excellent color density properties. This ink can be used on a variety of substrates but is particularly well suited for low surface tension substrates where chemical bonding between the substrate and ink is impractical. This ink is substantially free of volatile organic compounds and may be used in conventional high resolution flexographic and gravure printing processes.

In one of the preferred embodiments, the water-based ink composition includes a very low Tg° C. polymer component for providing adhesion to the substrate and wet rub resistance; a polyurethane dispersion for providing dry rub resistance; and a de-tackifier component for providing dry rub resistance.

Preferably, the de-tackifier is an inorganic material and may include talc. Also, preferably, the de-tackifier is between about 1 and 4 wt. % of the ink composition.

The ink composition may further include pigment loadings selected from the group consisting of organic and inorganic pigments and mixtures thereof. Preferably, the pigment loading is between about 10 and 16 wt. % of the ink composition.

Also, the ink composition may further include surfactants, as well as, also include lubricants selected from the group consisting of carnauba waxes, silicone oils and mixtures thereof. Preferably, the carnauba wax is between about 1 and 4 wt. % and the silicone oils are between about 1 and 3 wt. % silicone oil of the ink composition.

In one of the preferred embodiments, the Tg° C. of the water-based polymer component is less than about −80° C. Preferably, the very low Tg° C. polymer component is an acrylic latex and most preferably, the molecular weight of the acrylic latex is greater than about 200,000. Also preferably, the acid number of the acrylic latex is less than about 5. Preferably, the very low Tg° C. polymer component is between about 5 and 30 wt. % of the ink composition.

In one of the preferred embodiments, the polyurethane dispersion is a high elongation, high tensile strength and high hardness, water-based polymeric dispersion. Preferably, the molecular weight of the polyurethane dispersion is about 200,000 and the elongation is greater than about 500%, the tensile strength is greater than about 4000 psi and the hardness is greater than about 5 Shore A. Preferably, the polyurethane dispersion is between about 20 and 45 wt. % of the ink composition.

The ink composition may further include a resolubility agent. Preferably, the resolubility agent is a medium acid number, acrylic colloidal dispersion and, most preferably, the molecular weight of the acrylic colloidal dispersion is about 30,000, the acid number is about 95 and the Tg° C. is about +10° C. Preferably, the resolubility agent is between about 5 and 20 wt. % of said ink composition.

Accordingly, one aspect of the present invention is to provide a water-based ink composition for printing onto a substrate, said composition comprising a very low Tg° C. water-based, polymer component for providing adhesion to the substrate and wet rub resistance; and a binder for providing dry rub resistance.

Another aspect of the present invention is to provide a water-based ink composition for printing onto a substrate, said composition comprising a very low Tg° C. water-based polymer component for providing adhesion to the substrate and wet rub resistance; and a polyurethane dispersion for providing dry rub resistance.

Still another aspect of the present invention is to provide a water-based ink composition for printing onto a substrate, said composition comprising a very low Tg° C. polymer component for providing adhesion to the substrate and wet rub resistance; a polyurethane dispersion for providing dry rub resistance; and a de-tackifier component for providing dry rub resistance.

These and other aspects of the present invention will become apparent to those skilled in the art after a reading of the following description of the preferred embodiment when considered with the drawings.

### BRIEF DESCRIPTION OF THE DRAWINGS

FIG. 1 is a graphical representation of the crockfastness test values of various polymers illustrating the inverse relationship between wet and dry rub resistance for inks employing conventional Tg° C. polymers;

FIG. 2 is a graphical representation of the crockfastness test values of low to very low Tg° C. polymers illustrating the inverse relationship between wet and dry rub;

FIG. 3 is a graphical representation of the effect on crockfastness test values of varying ratios of PUD: acrylic polymer illustrating optimum ratios for ink systems prepared according to the present inventions;

FIG. 4 is a graphical representation of the effect on crockfastness test values of various levels of acrylic alone, PUD alone and PUD plus acrylic on dry rub illustrating the antagonistic effect of PUD on acrylic for the ink systems;

FIG. 5 is a graphical representation of the effect on crockfastness test values of various levels of acrylic alone, PUD alone and PUD plus acrylic on wet rub illustrating the synergy of PUD plus acrylic for the ink systems;

FIG. 6 is a graphical representation of the effect on crockfastness test values of various levels of acrylic alone, PUD alone and PUD plus acrylic on baby oil rub illustrating the synergy of PUD plus acrylic for the ink systems;

FIG. 7 is a graphical representation of the effect on crockfastness test values of various levels of a de-tackifier on crockfastness illustrating the optimum proportion of the de-tackifier for the ink systems; and

FIG. 8 is a graphical representation of the effect on crockfastness test values comparing ink versus ink plus over print varnish (OPV) illustrating the improved crockfastness of ink plus over print varnish for the ink system.

### DESCRIPTION OF THE PREFERRED EMBODIMENTS

In the following description, detailed information on components is found in Table 10. Also in the following description, it is to be understood that such terms as “forward,” “rearward,” “left,” “right,” “upwardly,” “downwardly,” and the like are words of convenience and are not to be construed as limiting terms.

For clarity, it is useful to define certain terms of art used herein:

“Colorant” refers to the combination of pigments and an acrylic colloidal dispersion.

“Color Density” refers to how vibrant a color is. Color density is quantified using a densitometer/spectrophotometer, which is a photo-electric device that measures and computes how much of a known amount of light is reflected from or transmitted through an object. It is an instrument used primarily in the printing, pre-press, and photographic industries to determine the strength of a color. “Crockfastness” refers to rub resistance, expressed on a scale of 1 to 5, with 5 showing no sign of transfer. The crockfastness data reported herein is determined using a certified AATCC Vertical Rotary Crockmeter, model M238E, supporting a 2×2″ certified white cotton crock cloth and rubbing in a reciprocal back and forth circular motion while applying 7.62 lbs./sq. inch against a printed substrate. The data reported herein was based on five full rotations of the crockmeter handle. The wet rub data herein was based on saturating the crock cloth to 65-75%, based on the weight of the cloth, with the specific test solution. The amount of color transferred to the crock cloth was measured and quantified as a Delta E using an X-Rite Spectrophotometer, model 939. Analytical settings were for CIE L.a.b., 45/0 geometry, D65 illumination, 16 mm aperture. The Delta E is then used in the following formulae to convert into a crockfastness value:

If Delta E (ΔE) is greater or equal to 12 the crocking value is calculated as:

Crocking value=5.063244^{(-0.059532×ΔE)}

If ΔE is less than 12 the crocking value is calculated as:

Crocking value=4.0561216^{(-0.041218×ΔE)}

The crocking values are reported as the average of N=3 with standard deviations.

“Environmentally friendly” refers to a composition with a VOC level of less than 1%.

“Glass Transition Temperature” generally refers to the temperature below which a given polymer is physically similar to glass (particularly a breakable solid), and above which the polymer behaves as a liquid, albeit of high viscosity. Tg° C. is an abbreviation for glass transition temperature, with Tg° C. referring to the glass transition temperature expressed in Celsius.

“Ink” and “composition” are used interchangeably herein, with the understanding that neither requires pigment.

A “low surface tension substrate”, used herein, refers to a substrate for receiving ink that exhibits a low surface tension and is therefore difficult to print with conventional inks or methods. These substrates are typically hydrophobic, apolar and inert. Examples of such substrates include webs of polyolefin polymer nonwoven fibers found in synthetic curtains and vertical blinds, feminine care products, diapers, incontinence pants, training pants and disposable wipes. Other examples are continuous films of extruded polyolefin polymer substrates.

“Polyurethane dispersion”, also known as PUD, is a polyurethane, which is dispersed in water. Used herein, PUD refers to a catalyst containing, unblocked, fully reacted polyurethane water dispersion. Preferably, the PUD is produced by mixing a diisocyanate, polyol and hydroxyl alkonoic acid to make an isocyanate terminated prepolymer. The prepolymer is then neutralized by an amine, preferably TEA, and dispersed in water. The chain is further extended by diamines such as EDA and IPD.

“Synurine” refers to a synthetic urine sample, which is prepared by solubilizing 2.0 g potassium chloride, 2.0 g sodium sulfate, 0.85 g ammonium phosphate monobasic, 0.15 g ammonium phosphate dibasic, 0.25 g calcium chloride dehydrate, and 0.50 g magnesium chloride hexahydrate in 1 liter of distilled water.

“Very low Tg° C.” used herein is about −82° C., with −80° C. considered “about −82° C.”.

“Volatile organic compounds”, also known as VOC's, include alcohols, esters, ketones, aromatics and aliphatics.

“Wet rub” used herein refers to crockfastness with Synurine.

“Wt %” refers to the percentage weight of a specific component relative to the entire composition.

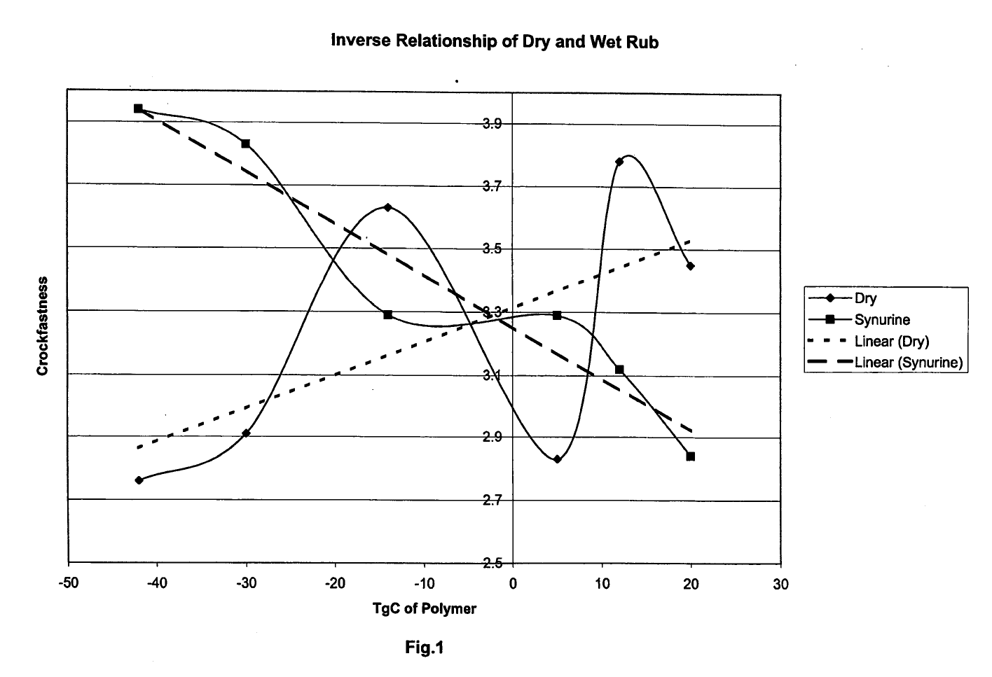

From a technical standpoint, formulating a VOC-free ink that adheres to a variety of hard-to-print substrates, yet provides excellent wet and dry crockfastness, as well as color density and printability, is a formidable task. Conventional inks generally have to sacrifice dry rub to optimize wet rub, and vice versa. This trend holds true even where different polymers are employed, as set forth in Table 1 and FIG. 1 (which includes linear trend lines):

TABLE 1
DRY VERSUS WET RUB FOR
CONVENTIONAL INKS

| | | Tg° C. of | | | |
|---|---|---|---|---|---|
| Sample | Polymer | Polymer | Dry | Synurine | Baby Oil |
| Ink N | Acrylic B | −42 | 2.76 | 3.94 | 1.81 |
| Ink R | Vinyl Ac B | 5 | 2.83 | 3.29 | 1.98 |
| Ink M | Acrylic A | −30 | 2.91 | 3.83 | 2.09 |
| Ink Q | Vinyl Ac A | 20 | 3.45 | 2.84 | 2.46 |
| Ink T | SBR B | −14 | 3.63 | 3.29 | 1.9 |
| Ink S | SBR A | 12 | 3.78 | 3.12 | 1.2 |

As can be seen above, the wet rub resistance in the state of the art ink compositions are generally not good. However, the Ink N and Ink M results did show that lower Tg° C. acrylics did have better Synurine wet rub results. The applicant then attempted to employ polymers with very low Tg° C.'s. These polymers were not used in the art since they are about as tacky to the touch as adhesive tape.

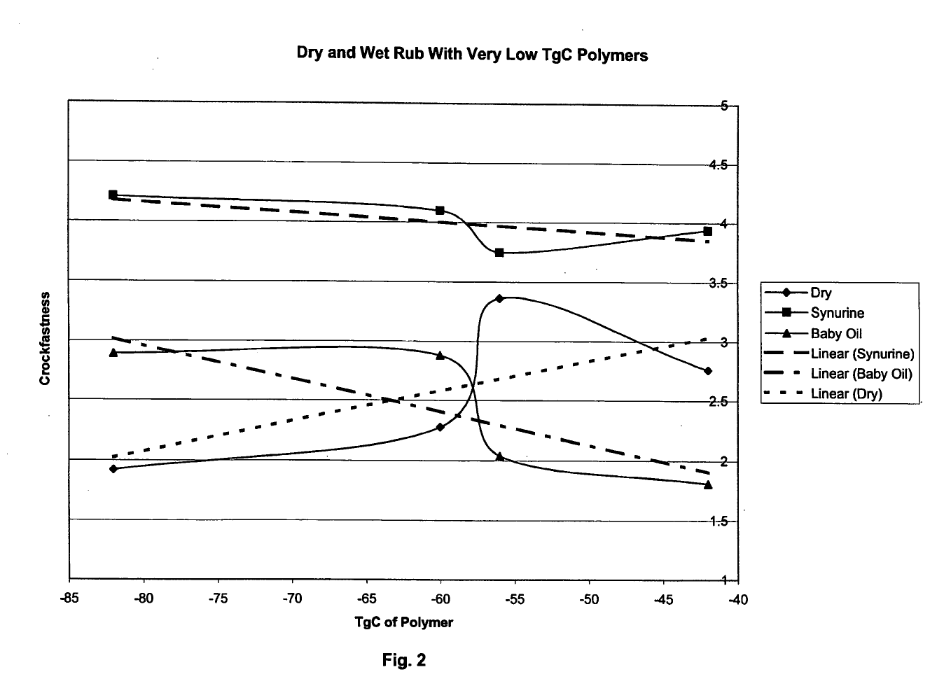

The test results are illustrated in Table 2 and FIG. 2 (which includes linear trend lines), with −42 Tg° C. shown for reference:

TABLE 2
DRY VERSUS WET RUB FOR NON-
CONVENTIONAL INKS

| | | Tg° C. of | | | |
|---|---|---|---|---|---|
| Sample | Polymer | Polymer | Dry | Synurine | Baby Oil |
| Ink P | Acrylic D | −82 | 1.92 | 4.21 | 2.89 |
| Ink O | Acrylic C | −60 | 2.28 | 4.10 | 2.88 |
| Ink U | SBR C | −56 | 3.36 | 3.75 | 2.04 |
| Ink N | Acrylic B | −42 | 2.76 | 3.94 | 1.81 |

The tested samples, inks M-U, contained the following:
38.0% Color Dispersion Blue 15:3
42.0% Various Polymers
5.0% Surfactants
4.0% Adhesion Promoter
10.5% Water
0.5% Aqueous Ammonia
   As can be seen, while the wet resistance did improve even further, the dry resistance generally worsened as the wet resistance improved. Thus, the challenge was how to keep the improved wet rub resistance while, at the same time, increase the dry rub resistance.

Waxes have been used in some ink compositions to improve dry rub resistance but only using relatively low levels of waxes. Tests were done to determine if increasing the levels of wax, much higher than those used in conventional inks, could impart improved dry rub resistance. Waxes' usefulness in conventional inks stems from their hydrophobic and lubricity properties. However, the applicant discovered that high levels of waxes appeared to form a layer above the very low Tg° C. polymer, which acted as a de-tackifier, thereby imparting improved dry rub resistance. This discovery was all the more unexpected given the fact that the degree of tack from the use of a −82Tg° C. polymer is equal to the grab of adhesive tape, and conceptually it seemed unlikely that adding wax could overcome this. Indeed, a −82 Tg° C. polymer is so tacky that merely touching it results in some of the polymer being carried off. Accordingly, its desirability as a vehicle for pigments appears limited since color would be mechanically carried off whenever touched.

The use of very high levels of wax showed promise. Accordingly, various formulations with wax were created and tested. Some of these formulations and associated rub data are set forth in Tables 3 and 4, respectively:

TABLE 3
FORMULATIONS OF INKS WITH WAX

| | | | | | | | | System | | System | | System |
|---|---|---|---|---|---|---|---|---|---|---|---|---|
| Components | System A | System B | System C | System D | System E | System F | System G | H | System I | J | System K | L |
| Acrylic A | 46.0 | | | | | | | | | | | |
| Acrylic B | | 46.0 | | | | | | | | | | |
| Acrylic C | | | 46.0 | | | | | | | | | |
| Acrylic D | | | | 46.0 | | | | | | | 23.0 | 21.0 |
| Vinyl Ac A | | | | | 46.0 | | | | | | | |
| Vinyl Ac B | | | | | | 46.0 | | | | | | |
| SBR A | | | | | | | 46.0 | | | | | |
| SBR B | | | | | | | | 46.0 | | | | |
| SBR C | | | | | | | | | 46.0 | | | |
| PUD | | | | | | | | | | 46.0 | 23.0 | 20.0 |
| Colorant^{a} | 38.0 | 38.0 | 38.0 | 38.0 | 38.0 | 38.0 | 38.0 | 38.0 | 38.0 | 38.0 | 38.0 | 37.0 |
| Surfactant^{b} | 3.0 | 3.0 | 3.0 | 3.0 | 3.0 | 3.0 | 3.0 | 3.0 | 3.0 | 3.0 | 3.0 | |
| Surfactant^{b2} | | | | | | | | | | | | 5.0 |
| Waxes^{c} | 8.0 | 8.0 | 8.0 | 8.0 | 8.0 | 8.0 | 8.0 | 8.0 | 8.0 | 8.0 | 8.0 | |
| Waxes^{c2} | | | | | | | | | | | | 12.0 |
| Water | 5.0 | 5.0 | 5.0 | 5.0 | 5.0 | 5.0 | 5.0 | 5.0 | 5.0 | 5.0 | 5.0 | 5.0 |
| total | 100 | 100 | 100 | 100 | 100 | 100 | 100 | 100 | 100 | 100 | 100 | 100 |

COMMENTS:
^{a}Dispersions mf'd from pigment blue 15.3/BT-24, DSM Neoresins of Wilmington, MA
^{b}1:1:1 Tego Wet 500, Goldschmidt Corp. of Hopewell, VA: Surfynol TG, Air Products of Allentown, PA: Igepal CO-630, Ashland Chemical of Columbus, OH
^{b2}Surfynol 465 from Air Products of Allentown, PA
^{c}62:25:13 blend DP-69, Shamrock Technology of Newark, NJ: S-Nauba 5021, Shamrock Technology of Newark, NJ: HS3000 Midwest Graphics Sales of Lisle, IL
^{c2}Slip Ayd SL-300, Elementis Specialties of Hightstown, NJ

TABLE 4
CROCKFASTNESS OF FORMULATIONS OF INKS WITH WAX

| | | | | | | | | | | System | | System |
|---|---|---|---|---|---|---|---|---|---|---|---|---|
| Rub Test | System A | System B | System C | System D | System E | System F | System G | System H | System I | J | System K | L |
| Dry Rub | 4.03 | 3.81 | 3.67 | 3.55 | 3.89 | 3.67 | 3.56 | 3.23 | 3.05 | 3.39 | 4.25 | 4.37 |
| Synurine | 3.25 | 3.67 | 4.09 | 4.63 | 3.27 | 3.79 | 1.79 | 3.28 | 2.86 | 2.97 | 3.22 | 4.55 |
| Rub | | | | | | | | | | | | |
| Baby Oil | 1.75 | 1.67 | 1.86 | 1.97 | 1.65 | 2.66 | 2.21 | 2.39 | 2.16 | 3.16 | 3.94 | 3.74 |
| Rub | | | | | | | | | | | | |
| avg. Rub | 3.01 | 3.05 | 3.21 | 3.38 | 2.93 | 3.36 | 2.52 | 2.98 | 2.69 | 3.17 | 3.80 | 4.22 |

As can be seen above, some samples included adding PUD to acrylic. These samples appeared to have the best overall crockfastness.

However, subsequent testing found that the dry rub resistance deteriorated over time with samples tested after 24 hrs not performing very well. Apparently, there is a long-term effect of combining wax with PUD, which has a detrimental effect. Specifically, it is hypothesized that the pigment-bound wax loses its ability to adhere to PUD as the wax migrates to the air-surface interface of the composition. As a result, the pigment-bound wax becomes acutely vulnerable to mechanical removal, i.e. it “flakes” off. Alternatively, or in addition, it is believed that non-woven fibers are so inherently flexible that, when distorted, the wax-containing composition simply cannot withstand the stress, and are stripped off.

Thus, the problem was how to maximize wet rub resistance while, at the same time, maintaining dry rub resistance, given that testing showed: (1) the PUD imparted the desirable dry rub and (2) the very low Tg° C. polymer with wax provided the desirable wet rub but (3) the PUD and the high wax resulted in a product that “flaked” off when tested. Thus, the high levels of wax solved the tackiness problem of the very low Tg° C. polymer but created its own problems. Also, while the very low Tg° C. polymer had solved the wet rub problem, it was too tacky to use without high levels of wax.

Since it was hypothesized that the high levels of waxes had functioned as a de-tackifier, the applicant began tests that substituted various materials that could act as a de-tackifier for very low Tg° C. polymer. After substantial testing, various formulations including talc finally provided the needed de-tackifying properties.

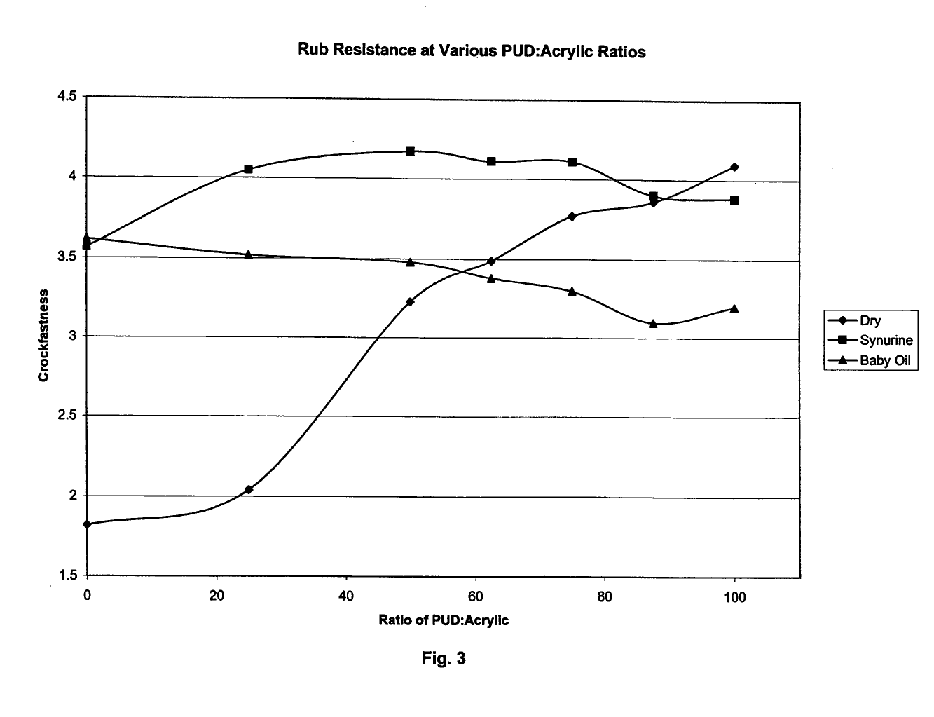

Having found a suitable de-tackifying agent to replace the high levels of wax, tests could now be performed to optimize the ratio of PUD to acrylic. Accordingly, various proportions were studied, as set forth in Table 5 and FIG. 3:

TABLE 5
RUB DATA WITH VARIOUS
BLENDS OF PUD:ACRYLIC

| PUD:ACRYLIC | Dry | Synurine | Baby Oil |
|---|---|---|---|
| 100.0 | 4.09 | 3.88 | 3.20 |
| 87.5 | 3.86 | 3.90 | 3.10 |
| 75.0 | 3.77 | 4.11 | 3.30 |
| 62.5 | 3.49 | 4.11 | 3.38 |
| 50.0 | 3.23 | 4.17 | 3.48 |
| 25.0 | 2.04 | 4.05 | 3.52 |
| 0.0 | 1.82 | 3.57 | 3.62 |

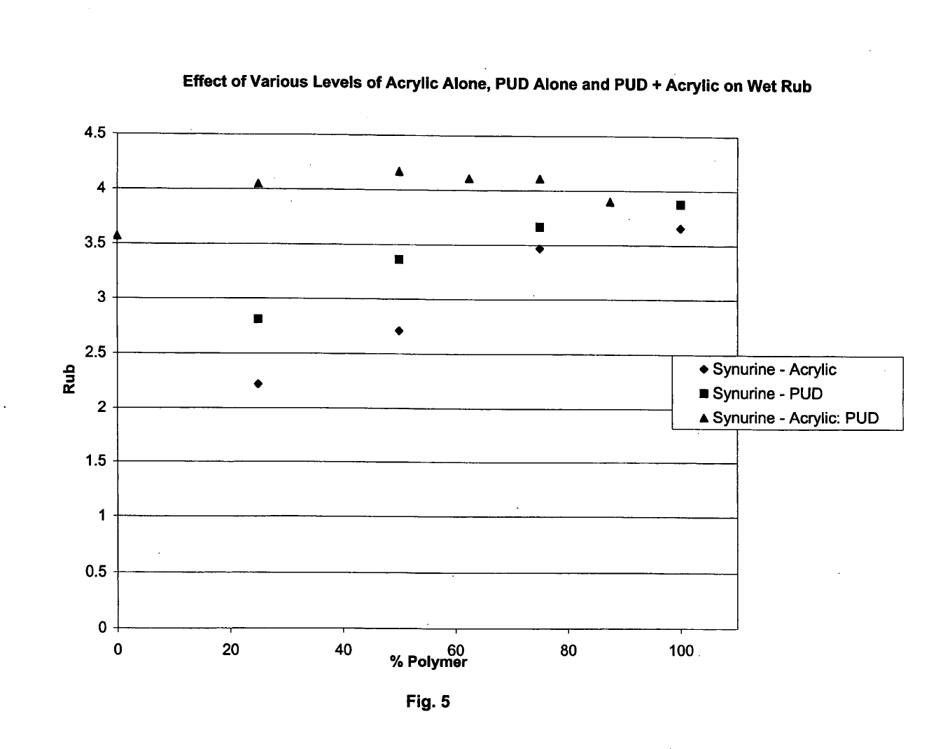

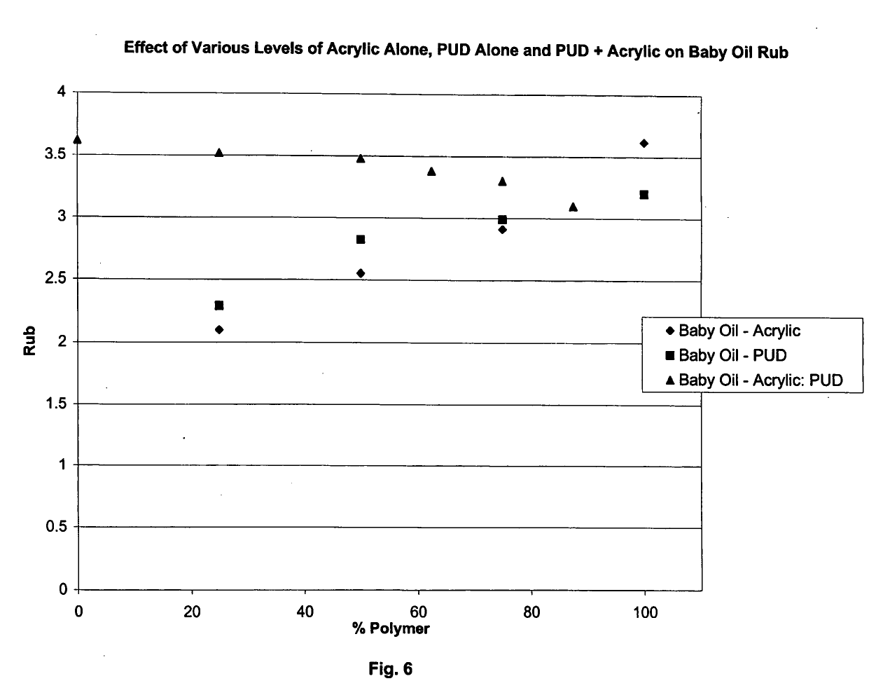

As can be seen above, it unexpected appeared that PUD and very low Tg° C. acrylic, when in specific proportions, acted in synergy. Accordingly, further studies were performed to determine if this was an experimental artifact or unexpected result. These results are shown in Table 6, and FIGS. 5 and 6.

TABLE 6
EFFECT OF ACRYLIC and/or PUD ON CROCKFASTNESS

| | | | | | | Baby | | | |
|---|---|---|---|---|---|---|---|---|---|
| | Dry- | Synurine- | Baby Oil- | Dry- | Synurine- | Oil- | Dry- | Synurine- | Baby Oil- |
| % | Acrylic | Acrylic | Acrylic | PUD | PUD | PUD | PUD:Acrylic | PUD:Acrylic | PUD:Acrylic |
| 0 | | | | | | | 1.82 | 3.57 | 3.62 |
| 25 | 1.37 | 2.22 | 2.10 | 2.55 | 2.81 | 2.29 | 2.04 | 4.05 | 3.52 |
| 50 | 1.23 | 2.71 | 2.55 | 3.44 | 3.36 | 2.82 | 3.23 | 4.17 | 3.48 |
| 62.5 | | | | | | | 3.49 | 4.11 | 3.38 |
| 75 | 1.35 | 3.47 | 2.91 | 3.81 | 3.67 | 2.99 | 3.77 | 4.11 | 3.30 |
| 87.5 | | | | | | | 3.86 | 3.90 | 3.10 |
| 100 | 1.28 | 3.66 | 3.62 | 4.09 | 3.88 | 3.20 | 4.09 | 3.88 | 3.20 |

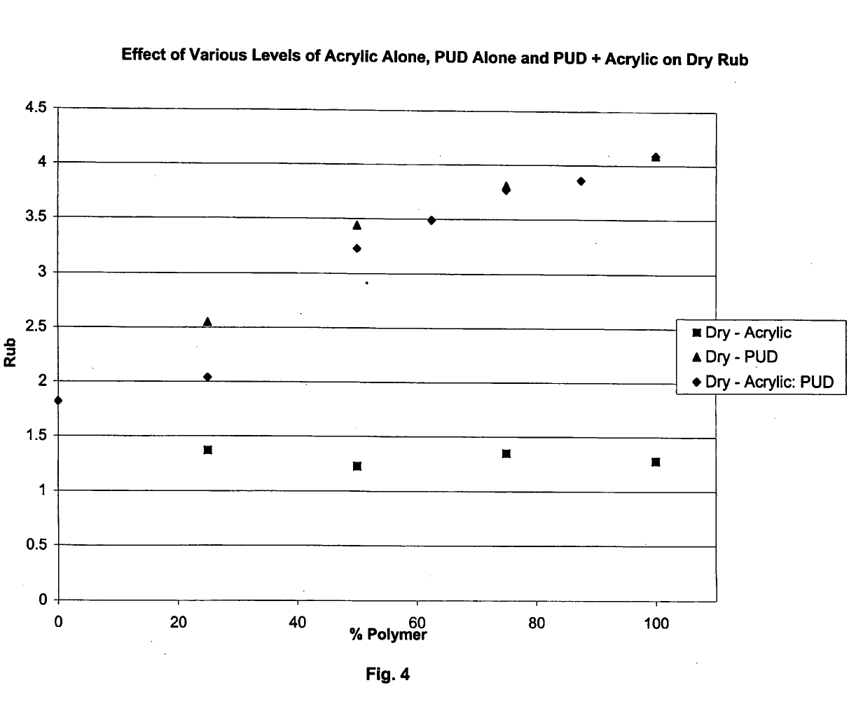

These tests show that approximately 75:25 PUD to −82 Tg° C. acrylic provide wet and baby oil rub resistance that is greater than the additive effect of their respective parts. However, as previously demonstrated in FIG. 4, dry rub resistance is primarily a function of the PUD and the acrylic actually exerts an antagonistic effect.

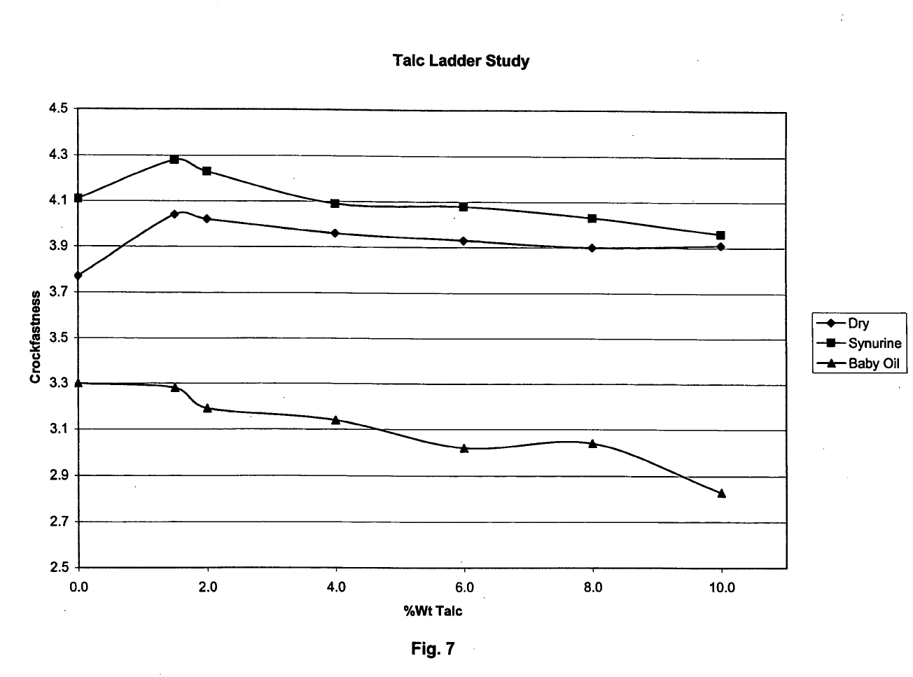

Having once established that 75:25 PUD/acrylic combination was unexpectedly synergistic, the applicant then went on to determine the optimum level of talc to de-tackify 75:25 PUD/acrylic with cyan pigment. This was determined by testing dry, wet and baby oil rub at increasing talc concentrations as shown below in Table 7 and FIG. 7:

TABLE 7
TALC LADDER STUDY

| % Talc | Dry | Synurine | Baby Oil |
|---|---|---|---|
| 0.0 | 3.77 | 4.11 | 3.30 |
| 1.5 | 4.04 | 4.28 | 3.28 |
| 2.0 | 4.02 | 4.23 | 3.19 |
| 4.0 | 3.96 | 4.09 | 3.14 |
| 6.0 | 3.93 | 4.08 | 3.02 |
| 8.0 | 3.90 | 4.03 | 3.04 |
| 10.0 | 3.91 | 3.96 | 2.83 |

As can be seen in Table 7 and FIG. 7, the optimum level is approximately 1.5-6.0 wt. %, with 1.5% wt. % being most preferred.

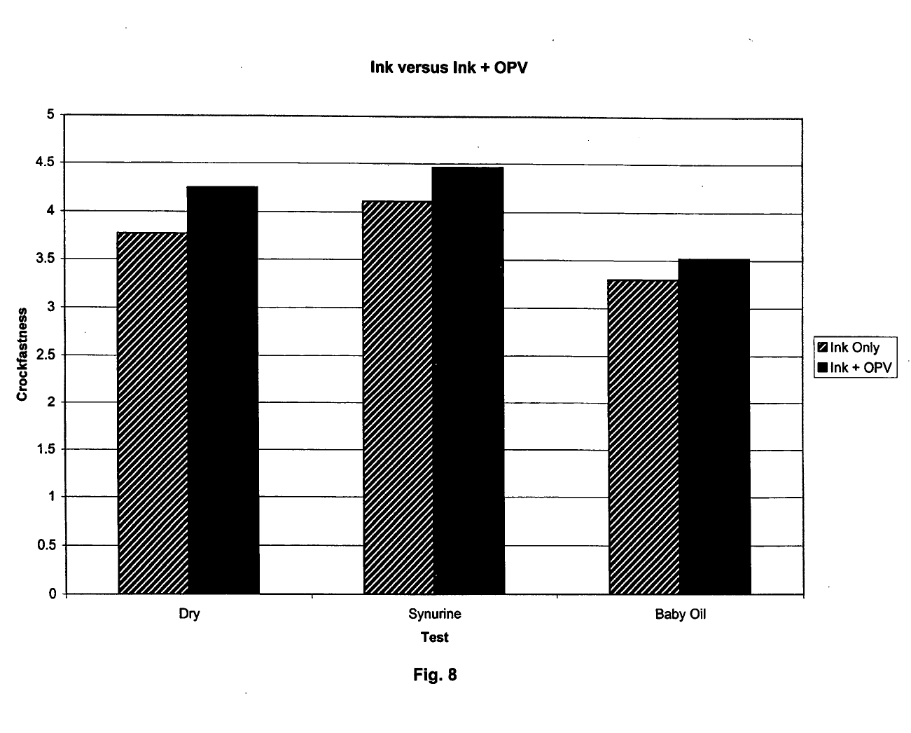

Finally, having discovered a preferred novel and unexpected composition, the applicant tested this composition with a protective Over Print Varnish (“OPV”) as shown below in Table 8 and FIG. 8.

TABLE 8
INK VERSUS INK + OPV

| Formula | Dry | Synurine | Baby Oil |
|---|---|---|---|
| Ink Only | 3.77 | 4.11 | 3.30 |
| Ink + OPV | 4.25 | 4.46 | 3.52 |

As can be seen in Table 8 and FIG. 8, the OPV significantly improved the crockfastness.

Table 9 sets forth the preferred composition of the present inventions, with the source and identity of the components set forth in Table 10:

TABLE 9
PREFERRED COMPOSITION

| COMPONENT | wt % |
|---|---|
| Acrylic latex | 11.00 |
| Polyurethane Dispersion | 33.00 |
| Colloidal dispersion | 7.10 |
| Pigments | 12.60 |
| Talc | 1.65 |
| Surfactant | 5.50 |
| Water | 27.50 |
| Aqueous Ammonia | 1.50 |
| Defoamer | 0.15 |
| TOTAL | 100.00 |

TABLE 10
Components used in Formulations

| Component | Source |
|---|---|
| Acrylic A | Joncryl 624 (BASF of Florham, NJ) |
| Acrylic B | Sequabond 9056 (Omnova Solutions of Chester, SC) |
| Acrylic C | Rhoplex 1950 (Rhom & Haas of Philadelphia, PA) |
| Acrylic D | Rovene 6005 (Mallard Creek Polymer of Charlotte, NC |
| Adhesive | CP 349W (Eastman Chemical Co. of Kingsport, TN) |
| Promoter | |
| Ammonia | 26° aqueous ammonia (Ashland Specialty Chemical of Columbus, OH) |
| Black Colorant | Black 7//BT-24 (DSM Neoresins of Wilmington, MA) |
| Blue Colorant | Blue 15.3/BT-24 (DSM Neoresins of Wilmington, MA) |
| Carnauba Wax | S-Nauba 5021 (Shamrock Technologies of Newark, NJ) |
| Colloidal Dispersion | BT-24 (DSM Neoresins of Wilmington, MA) |
| PUD | NeoRez R9621 (DSM Neoresins of Wilmington, MA) |
| SBR A | Rovene 4180 (Mallard Creek Polymer of Charlotte, NC) |
| SBR B | Rovene 4150 (Mallard Creek Polymer of Charlotte, NC) |
| SBR C | Rovene 9410 (Mallard Creek Polymer of Charlotte, NC) |
| Silicone Emulsion | HS-3000 (Midwest Graphic Sales of Lisle, IL) |
| Surfactant | Surfynol 465 (Air Products of Allentown, PA) |
| Surfactant Blend | 1:1:1 of Surfynol TG (Air Products of Allentown, PA), Igepal CO-630 (Ashland |
| | Specialty Chemicals of Columbus, OH) and Tego Wet 500 (Goldschmidt |
| | Corp. of Hopewell, VA) |
| Talc | WEMP 12-50 (Mineral and Pigment Solutions Inc., South Plainfield, NJ. |
| Vinyl Ac A | Vancryl 825 (Cytec Industries of Smyrna, GA) |
| Vinyl Ac B | Vancryl 650 (Cytec Industries of Smyrna, GA) |
| Water | Distilled from any convenient source |
| Wax A | Jonwax #4 (BASF of Philadelphia, PA) |
| Wax B | DP-69 (Shamrock Technologies of Newark, NJ) |
| Wax Blend | 62% wt of paraffin emulsion DP-69 (Shamrock Technologies of Newark, NJ), |
| | 25% carnauba wax S-Nauba 5021 (Shamrock Technologies of Newark, NJ) |
| | and 13% silicone emulsion HS-3000 (Midwest Graphics Sales of Naperville, |
| | IL) |
| Wax C | AQ-60 (Shamrock Technologies of Newark, NJ) |
| Wax D | S-Nauba 5021 (Shamrock Technologies of Newark, NJ) |
| Wax E | HS-3000 (Midwest Graphic Sales of Lisle, IL) |
| Wax F | Slip Ayd SL-300 (Elementis Specialties Inc. of Jersey City, NJ) |

The present invention is a water-based ink composition for printing onto a substrate. The ink includes a very low Tg° C. water-based polymer component for providing adhesion to the substrate and wet rub resistance, plus a binder component for providing dry rub resistance. The binder is preferably a polyurethane dispersion.

Preferably, the very low Tg° C. polymer is 11 wt. % of an acrylic latex with a molecular weight greater than about 200,000 and acid number less than about 5. However, polymers of about 5-30% by weight are also within the scope of the invention. Moreover, although −82 Tg° C. polymers, or less than about −80 Tg° C. polymers are most preferred, polymers of less than 42 Tg° C. would also be suitable. Examples of suitable very low Tg° C. polymers include acrylics, styrenated acrylics, ethylene vinyl acetate, ethylene vinyl chlorides and styrene butadiene rubbers (SBR's).

Preferably, the binder component is 33 wt. % of the present invention. However, 20 to 45 wt. % could be employed. The preferred binder is a PUD. The PUD is preferably a high elongation, high tensile strength, high hardness, water-based polymeric dispersion. Most preferably, the molecular weight of the PUD is about 200,000, the elongation is greater than about 500%, the tensile strength is greater than about 4,000 psi and the hardness is greater than about 5 Shore A.

Preferably, the ink includes a de-tackifier to provide or improve rub resistance. Suitable de-tackifiers include inorganic materials, with 1 to 4 wt. % talc being preferred. Most preferably, approximately 1.65 wt. % talc is used. Other potential de-tackifiers include calcium carbonate, silicas and magnesium stearates.

This ink may include a resolubility agent that allows efficient use of ink in standard printing equipment by effectively re-dissolving ink residue left in a printing well between prints. Preferably, the resolubility agent is about 7.5 wt. %. However, 5-20 wt. % resolubility agent could be employed. Possible resolubility agents include acrylics solutions and dispersions with a high to medium degree of carboxyl functionality. Of particular interest are medium acid number, acrylic colloidal dispersion, resolubility agents, especially those where the molecular weight is about 30,000, the acid number is about 95 and the Tg° C. is about +10. Examples include BT-24 and A-1125, both from DSM Neoresins of Wilmington, Mass.

The ink optionally includes additional waxes and lubricants for de-tackification and lowering CoF. Ideally the additional wax/lubricant blend is composed of about 1 to 4 wt. % carnauba (the wax), and about 1 to 3 wt. % silicone oil (the lubricant). The preferred wt. % of the wax/lubricant blend is 4%. Other potential waxes include polyethylene, polypropylenes, high density polyethylene, low density polyethylene and paraffin.

Although not necessary, the ink may include pigments. Examples of suitable pigments include, but are not limited to, Blue 15:3, Violet 23, Violet 27, Yellow 14, Yellow 74, Yellow, 83, Yellow 97, Yellow 13, Green 7, Red 2, Red 22, Red 48:1, Red 57:1, Red 122, Red 184, Red 238, Red 269, Red 49:1, Red 81:1 Red 49:2, Red 166, Red 170, Orange 5, Orange 16, Orange 46, White 7, Black 7, iron oxides, and combinations thereof. Preferably, approximately 10-16 wt. % pigments are employed, but this is understood to vary according to the specific color and desired density. Pigments in a colloidal dispersion, collectively a colorant, are preferred.

The ink composition ideally includes surfactants to reduce the dynamic surface tension of the fluid inks, without the use of high VOC solvents, in order to closely match the surface tension of the substrate. Chosen polymers necessary to achieve good adhesion and rub resistance have surface tensions about 50-60 dynes/cm³ while untreated polyolefin substrates can be below 30 dynes/cm³. Surfactants are preferably present at approximately 4.5 wt %, but could be present anywhere in the range of 1.0% to 6.0%. Suitable surfactants include those listed on Table 7 as well as: dioctyl sulfosuccinates, such as Aerosol MA-80-I from Cytec Industries of Willow Island, W. Va.; phosphate esters, such as Strodex PK-90 from Hercules Inc. of Brunswick, Ga., alkoxylated alcohols, such as Tego Wet 500 from Goldschmidt Corp. of Hopewell, Va.; and ethoxylated diols, such as Surynol SEF from Air Products of Allentown, Pa. The preferred surfactant is Surfynol 465, manufactured by Air Products of Allentown, Pa.

Referring now to the preferred embodiment of Table 9, the method of making this ink is to begin by manufacturing the color dispersions or colorants using the following formula:

19.6 wt. % BT-24 acrylic colloidal dispersion from DSM Neoresins of Wilmington, Ma.

35.0 wt. % Dry pigment (appropriate color)

44.2 wt. % Water

1.2 wt. % Aqueous ammonia 26°

This slurry should be mixed on a high speed disperser until the pigment particle size reaches 150-200 microns as measured on a Hegman Grind Gauge. Once accomplished, the slurry is processed through a shot mill until the pigment particle size is from 0 to 6 microns. The color dispersion is then complete and ready for use. All other components in the preferred embodiment can then be easily stirred into the colorant in the following order:

36.0 wt. % colorant

11.0 wt. % acrylic D (Rovene 6005)

33.0 wt. % PUD (Neorez R9621)

1.65 wt. % Talc (WEMP 12-50)

5.5 wt. % Surfactant (Surfynol 465)

12.2 wt. % Water

0.5 wt. % Aqueous Ammonia

0.15 wt. % Defoamer

The method of using the ink is to apply onto the substrate with either a flexographic or a gravure printing press. A metering roll system or doctor blade system can be used. The cell volume of the anilox (flexographic) or cylinder (gravure) is based on the desired color density and in the case of nonwoven substrates, by the weight of the nonwoven. The preferred embodiment is capable of printing in excess of 500 ft/min, and only requiring minimal adjustments in pH. The crockfastness data presented was based on the preferred embodiment being applied to a 27 GSM HEC polypropylene nonwoven substrate using a 5.6 bcm anilox with doctor blade.

Turning now to the OPV, the composition is preferably 44.8 wt. % PUD; 11.0 wt. % acrylic D; 16.6 wt. % colloidal dispersion; 5.5 wt. % surfactant; 1.65 wt % talc; 20.0 wt. % water; and 1.45 wt. % ammonia. The preferred method of making the OPV is as follows:

The components are compatible with one another and easily stirred together using an air or electric mixer, but should be added in the following sequence while mixing:

44.8% PUD (NeoRez R-9621)

11.0% Acrylic D (Rovene 6005)

20.0% Water

1.65% Talc (WEMP-12-50)

1.45% Aqueous Ammonia 26°

16.6% Colloidal dispersion (BT-24)

5.5% surfactant (Surfynol 465)

The pH of the overprint varnish (OPV) was adjusted to 9.2 to 9.6 with aqueous ammonia and a viscosity of 20-25″ using a #2 Zahn cup with water.

The preferred method of using the OPV is to apply either by means of a flexographic or rotogravure printing press. A metering roll system or doctor blade system can be used. The cell volume of the anilox (flexo) or cylinder (gravure) is based on the desired rub resistance requirements. The preferred embodiment is capable of printing in excess of 500 ft/min with only minor adjustments to pH. The crockfastness data presented was based on the preferred embodiment being printed on a 27 gsm nonwoven polypropylene substrate using a 5.6 BCM anilox with doctor blade.

Certain modifications and improvements will occur to those skilled in the art upon a reading of the foregoing description. By way of example, the use of surfactant-based pigment dispersions or resin-based pigment dispersions containing conventional high acid number, low molecular weight polymers can be a viable option depending on the type of substrate to be printed, the type of printing process, i.e. flexograghic, rotogravure, ink jet, etc., and the degree of rub resistance required. Also, the use of plasticizers, which behave as spacers between polymer particles to increase flexibility, could be incorporated. This is viewed as less desirable, however, given plasticizers' tendency to remain in a wet form and migrate out of an ink film onto a contacting surface over time, or in elevated heat conditions.

It should be understood that all such modifications and improvements have been deleted herein for the sake of conciseness and readability but are properly within the scope of the following claims.

I claim:

1. A water-based ink composition for printing onto a substrate, said composition comprising:
(a) a very low Tg° C. water-based, polymer component for providing adhesion to the substrate and wet rub resistance; and
(b) a binder for providing dry rub resistance.

2. The ink composition according to claim 1, further including a de-tackifier component for providing dry rub resistance.

3. The ink composition according to claim 2, wherein said de-tackifier is an inorganic material.

4. The ink composition according to claim 3, wherein said de-tackifier includes talc.

5. The ink composition according to claim 2, wherein said de-tackifier is between about 1 and 4 wt. % of said ink composition.

6. The ink composition according to claim 1, further including pigment loadings selected from the group consisting of organic and inorganic pigments and mixtures thereof.

7. The ink composition according to claim 6, wherein the pigment loading is between about 10 and 16 wt. % of said ink composition.

8. The ink composition according to claim 1, further including surfactants.

9. The ink composition according to claim 1, further including lubricants selected from the group consisting of carnauba waxes, silicone oils and mixtures thereof.

10. The ink composition according to claim 9, wherein said carnauba wax is between about 1 and 4 wt. % and said silicone oils are between about 1 and 3 wt. % silicone oil of said ink composition.

11. A water-based ink composition for printing onto a substrate, said composition comprising:
(a) a very low Tg° C. water-based polymer component for providing adhesion to the substrate and wet rub resistance; and
(b) a polyurethane dispersion for providing dry rub resistance.

12. The ink composition according to claim 11, wherein the Tg° C. of said water-based polymer component is less than about −80° C.

13. The ink composition according to claim 11, wherein said very low Tg° C. polymer component is an acrylic latex.

14. The ink composition according to claim 13, wherein the molecular weight of said acrylic latex is greater than about 200,000.

15. The ink composition according to claim 13, wherein the acid number of said acrylic latex is less than about 5.

16. The ink composition according to claim 11, wherein said very low Tg° C. polymer component is between about 5 and 30 wt. % of said ink composition.

17. The ink composition according to claim 11, wherein said polyurethane dispersion is a high elongation, high tensile strength and high hardness, water-based polymeric dispersion.

18. The ink composition according to claim 17, wherein the molecular weight of said polyurethane dispersion is about 200,000 and the elongation is greater than about 500%, the tensile strength is greater than about 4000 psi and the hardness is greater than about 5 Shore A.

19. The ink composition according to claim 11, wherein said polyurethane dispersion is between about 20 and 45 wt. % of said ink composition.

20. The ink composition according to claim 11, further including a resolubility agent.

21. The ink composition according to claim 20, wherein said resolubility agent is a medium acid number, acrylic colloidal dispersion.

22. The ink composition according to claim 21, wherein the molecular weight of said acrylic colloidal dispersion is about 30,000 and the acid number is about 95 and the Tg° C. is about +10° C.

23. The ink composition according to claim 20, wherein said resolubility agent is between about 5 and 20 wt. % of said ink composition.

24. A water-based ink composition for printing onto a substrate, said composition comprising:
(a) a very low Tg° C. polymer component for providing adhesion to the substrate and wet rub resistance;
(b) a polyurethane dispersion for providing dry rub resistance; and
(c) a de-tackifier component for providing dry rub resistance.

25. The ink composition according to claim 24, wherein said de-tackifier is an inorganic material.

26. The ink composition according to claim 25, wherein said de-tackifier includes talc.

27. The ink composition according to claim 24, wherein said de-tackifier is between about 1 and 4 wt. % of said ink composition.

28. The ink composition according to claim 24, further including pigment loadings selected from the group consisting of organic and inorganic pigments and mixtures thereof.

29. The ink composition according to claim 28, wherein the pigment loading is between about 10 and 16 wt. % of said ink composition.

30. The ink composition according to claim 24, further including surfactants.

31. The ink composition according to claim 24, further including lubricants selected from the group consisting of carnauba waxes, silicone oils and mixtures thereof.

32. The ink composition according to claim 31, wherein said carnauba wax is between about 1 and 4 wt. % and said silicone oils are between about 1 and 3 wt. % silicone oil of said ink composition.

33. The ink composition according to claim 24, wherein the Tg° C. of said water-based polymer component is less than about −80° C.

34. The ink composition according to claim 24, wherein said very low Tg° C. polymer component is an acrylic latex.

35. The ink composition according to claim 34, wherein the molecular weight of said acrylic latex is greater than about 200,000.

36. The ink composition according to claim 34, wherein the acid number of said acrylic latex is less than about 5.

37. The ink composition according to claim 24, wherein said very low Tg° C. polymer component is between about 5 and 30 wt. % of said ink composition.

38. The ink composition according to claim 24, wherein said polyurethane dispersion is a high elongation, high tensile strength and high hardness, water-based polymeric dispersion.

39. The ink composition according to claim 38, wherein the molecular weight of said polyurethane dispersion is about 200,000 and the elongation is greater than about 500%, the tensile strength is greater than about 4000 psi and the hardness is greater than about 5 Shore A.

40. The ink composition according to claim 24, wherein said polyurethane dispersion is between about 20 and 45 wt. % of said ink composition.

41. The ink composition according to claim 24, further including a resolubility agent.

42. The ink composition according to claim 41, wherein said resolubility agent is a medium acid number, acrylic colloidal dispersion.

43. The ink composition according to claim 42, wherein the molecular weight of said acrylic colloidal dispersion is about 30,000 and the acid number is about 95 and the Tg° C. is about +10° C.

44. The ink composition according to claim 41, wherein said resolubility agent is between about 5 and 20 wt. % of said ink composition.
